(19) United States
(12) Patent Application Publication
(10) Pub. No.: US 2013/0257045 A1
(43) Pub. Date: Oct. 3, 2013

(54) HOUSING TYPE PIPE JOINT

(71) Applicant: KABUSHIKI KAISHA RIKEN, Tokyo (JP)

(72) Inventor: Syuichi Mikami, Saitama (JP)

(73) Assignee: Kabushiki Kaisha Riken, Tokyo (JP)

(21) Appl. No.: 13/852,055

(22) Filed: Mar. 28, 2013

(30) Foreign Application Priority Data
Mar. 30, 2012 (JP) 2012-080320

(51) Int. Cl. F16L 17/04

(52) U.S. Cl. CPC F16L 17/04
USPC 285/364

(57) ABSTRACT

A housing type pipe joint 1 that connects a pair of pipes P, comprising: a plurality of housing bodies 4; an annular gasket 6 that is accommodated in the housing body; the gasket includes a cylindrical body portion 6c, a pair of gasket lip portions 6a to seal an outer surface of the pipe, and a pair of gasket tongue portions 6b between the gasket lip portions, when the distal ends of the pair of gasket tongue portions are pressed to be close to each other in the axial direction, the body portion is deformed about a vicinity of base ends of the pair of gasket tongue portions, and due to this deformation, the pair of gasket lip portions rotate, and an angle of the outer surface 6as of the gasket lip portion relative to the axial direction becomes smaller.

The present U.S. patent application claims priority to Japanese Patent Application No. 2012-080320, filed Mar. 30, 2012, the disclosure of which is incorporated herein by reference in its entirety.

### FIELD OF THE INVENTION

The present invention relates to a housing type pipe joint that connects pipes to each other with an end of each of the pipes butting against each end of the joint.

### DESCRIPTION OF THE RELATED ART

A known configuration of a conventional housing type pipe joint 100 is shown in FIGS. 8 and 9, in which an annular gasket 60 is accommodated in an inner-diameter portion of a pair of housing bodies 40 that are substantially semi-arc shaped portions, and flange portions 50 protruding from both ends of the respective semi-arc shaped portions face each other, and are fixed by a fastener 70 including a bolt 80 and a nut 90.

The housing type pipe joint 100 is installed as follows. First, the bolt 80 and the nut 90 are removed, and then the gasket 60 is attached to one pipe P closer to its edge rather than an annular groove Pa. Because the inner diameter of the gasket 60 is smaller than the outer diameter of the pipe P, the gasket 60 while being stretched is attached to the pipe P. An end of the other pipe P is then inserted into the gasket 60 in order that the end butts against an end of the one pipe P, and the gasket 60 is arranged across both the ends of the pipes P. FIG. 10 is a half sectional view of the gasket 60 including a gasket lip portion 60a on each axial side of the gasket 60. An outer diameter d₁ of the pipe P is larger than an inner diameter of the gasket lip portion 60a. When the pipe P is inserted into the gasket 60, the pipe P comes into contact with the gasket lip portion 60a. When the pipe P is further inserted into the gasket 60, the gasket lip portion 60a is deformed, thereby sealing an outer surface of the pipe P.

Next, the pair of housing bodies 40 cover a connecting portion of the pipes P from above the gasket 60, and a lug portion 40a protruding from the semi-arc shaped portion of the housing body 40 to its inner diameter side is mounted into the annular groove Pa of the pipe P to engage with each other in order to position the housing bodies 40 in the axial direction. Further, the bolt 80 is inserted into bolt holes of the opposed flange portions 50 of the housing bodies 40, and is fastened by the nut 90, thereby fixing the connecting portion of the pipes.

In recent years, for the purpose of reducing installation time and cost, an insert-type housing type pipe joint has been provided, in which ends of a pair of pipes P formed with an annular groove Pa are inserted from both axial sides of the housing type pipe joint that is a pre-assembled unit (not shown) with the ends of the pipes P coaxially butting against each other, and then a bolt and a nut that are pre-assembled into opposed flange portions of housing bodies are fastened to fix the ends of the pipes P (Patent Literature 1).

In the insert-type housing type pipe joint, an inner diameter of a gasket is set larger than an outer diameter d₁ of the pipe P in order that in a pre-assembled state, the end of the pipe P can be easily inserted into the gasket. FIG. 11 is a half sectional view of a gasket 65 used in the insert-type housing type pipe joint. The gasket 65 includes a positioning protruding portion 65c that extends along the axial direction between gasket lip portions 65a and comes into contact with the ends of the pipes P. The outer diameter d₁ of the pipe P is smaller than the inner diameter of the gasket lip portion 65a, and is larger than the inner diameter of the positioning protruding portion 65c.

### PRIOR ART LITERATURE

### Patent Literature

[Patent Literature 1] Japanese Unexamined Patent Application Publication (Translation of PCT Application) No. 2007-537414

### SUMMARY OF THE INVENTION

### Problems to be Solved by the Invention

As shown in FIG. 11, in a case of the insert-type housing type pipe joint described above, in the gasket 65, the inner diameter of the gasket lip portion 65a that seals a pipe is larger than the outer diameter d₁ of the pipe P. Therefore, when the housing bodies are fastened by a fastener (a bolt and a nut), the gasket 65 is pressed in the radial direction, thereby decreasing its diameter and tightly attaching the gasket lip portion 65a to an outer surface of the pipe to seal the outer surface.

However, when the diameter of the gasket 65 is decreased, the gasket (the gasket lip portion 65a) is twisted and wrinkled, thereby causing twists and wrinkles due to the decrease in diameter. When the gasket 65 is held in such an excessively compressed state for a long time, the gasket 65 becomes deteriorated. Accordingly, there is a concern that sealing performance of the gasket 65 degrades and water leakage occurs.

Therefore, the object of the present invention is to provide a housing type pipe joint that solves the above problems, prevents a gasket (a gasket lip portion) from causing twists and wrinkles and from being excessively compressed, can suppress deterioration of the gasket even when the gasket is held for a long time, and can prevent degradation of sealing performance of the gasket and water leakage.

### Means for Solving the Problems

The present invention provides a housing type pipe joint that connects a pair of pipes including a concave or convex mounting portion at an end thereof, the joint comprising:

a plurality of housing bodies, each of which includes an arc-shaped portion, a flange portion that is formed at each circumferential end of the arc-shaped portion and protrudes radially outward, a pair of engaging portions that are arranged respectively on an axially-extending inner surface of the arc-shaped portion and engage respectively with the mounting portion of the pipe, and a concave portion that defines an interior space of the arc-shaped portion along the axial direction between the pair of engaging portions;

an annular gasket that is formed from an elastic member and is accommodated in the concave portion of the housing body; and

a fastener that fastens the housing bodies at the flange portions, wherein

the gasket includes a cylindrical body portion, a pair of gasket lip portions that extend radially inward from both axial-end sides of the body portion, and a pair of gasket tongue portions that extend radially inward from an inner surface of the body portion along the axial direction between the pair of gasket lip portions,

an outer surface of the gasket lip portion is tightly attached to an outer surface of the pipe, and is capable of sealing the outer surface,

in a state where no load is applied to the gasket, distal ends of the pair of gasket tongue portions are spaced apart from each other in the axial direction, and

when the distal ends of the pair of gasket tongue portions are pressed to be close to each other in the axial direction, the body portion is deformed about a vicinity of base ends of the pair of gasket tongue portions, and due to this deformation, the pair of gasket lip portions rotate, and an angle of the outer surface of the gasket lip portion relative to the axial direction becomes smaller.

According to the above housing type pipe joint, when the gasket lip portion rotates, the angle of the outer surface of the gasket lip portion relative to the axial direction becomes smaller. Therefore, when the housing type pipe joint is fully fastened to reduce a clearance between the housing bodies, the outer surface of the gasket lip portion can be easily tightly attached to the outer surface of the pipe. As a result of this, the gasket (the gasket lip portion) can be prevented from causing twists and wrinkles and from being excessively compressed, deterioration of the gasket can be suppressed even when the gasket is held for a long time, and degradation of sealing performance of the gasket and water leakage can be prevented.

Further, the gasket tongue portions can position the pipes at the time of connecting the pipes, thereby improving workability.

Preferably, as viewed in the axial direction, a width of the gasket in a state where no load is applied thereto is larger than a width of the concave portion, and

when the distal ends of the pair of gasket tongue portions are pressed to be close to each other in the axial direction, the width of the gasket becomes equal to or smaller than the width of the concave portion, and the gasket is completely accommodated in the concave portion.

According to this housing type pipe joint, when the gasket is accommodated in the concave portion to be pre-assembled into it, the gasket is locked by the concave portion because the width of the gasket is larger than the width of the concave portion, thereby preventing the gasket from coming off and the axial center from displacing. Further, when the distal ends of the pair of gasket tongue portions are close to each other, the width of the gasket becomes equal to or smaller than the width of the concave portion. Therefore, when the housing type pipe joint is fully fastened, the gasket is completely accommodated in the concave portion almost without being compressed, and accordingly the gasket can be prevented from causing twists and wrinkles and being excessively compressed.

Preferably, a center ring is interposed between the pair of gasket tongue portions.

The gasket tongue portion can be possibly deformed, damaged, or the like due to, for example, a pipe bending load. In this case, the gasket tongue portion does not perform the function of positioning the pipes. Therefore, a center ring is provided to enable the pipes to be reliably positioned.

Preferably, the center ring is formed from rubber, resin, or metal.

### Effect of the Invention

According to the present invention, a gasket (a gasket lip portion) can be prevented from causing twists and wrinkles and from being excessively compressed, deterioration of the gasket can be suppressed even when the gasket is held for a long time, and degradation of sealing performance of the gasket and water leakage can be prevented.

### BRIEF DESCRIPTION OF THE DRAWINGS

FIG. 1 is a sectional view of a housing type pipe joint according to an embodiment of the present invention, taken along the plane parallel to an axial direction of pipes when the housing type pipe joint is mounted thereon;

FIG. 2 is a sectional view taken along the line A-A in FIG. 1;

FIG. 3 is a half sectional view of the housing type pipe joint taken along the plane parallel to the axial direction;

FIG. 4 is a half sectional view of a gasket;

FIGS. 5 are explanatory views of an operation of the gasket when the pipes are connected to the housing type pipe joint;

FIG. 6 is a half sectional view of the gasket with a center ring interposed between gasket tongue portions;

FIG. 7 is a half sectional view of a modification of the gasket;

FIG. 8 is a sectional view of a conventional housing type pipe joint taken along a direction perpendicular to the axial direction;

FIG. 9 is a sectional view of the conventional housing type pipe joint taken along the axial direction;

FIG. 10 is a half sectional view of a conventional gasket; and

FIG. 11 is a half sectional view of a conventional gasket used in an insert-type housing type pipe joint.

### DESCRIPTION OF THE EMBODIMENTS

The present invention is described below in detail. However, the present invention is not limited thereto.

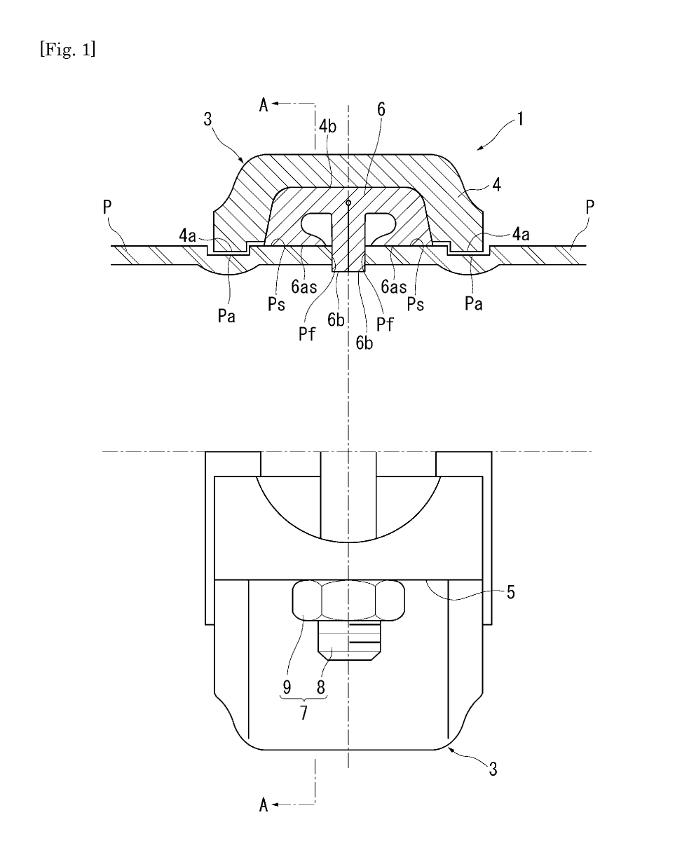

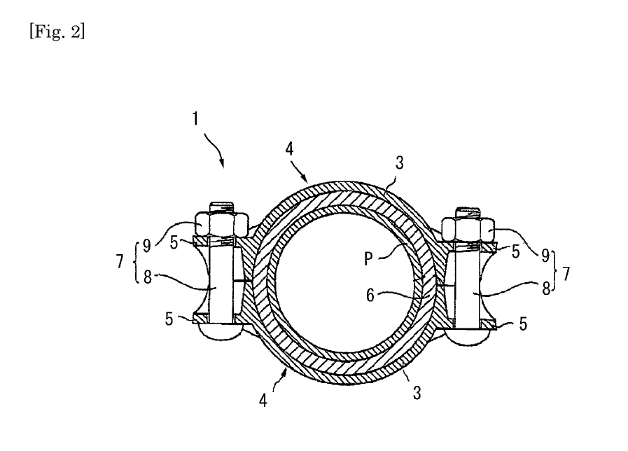

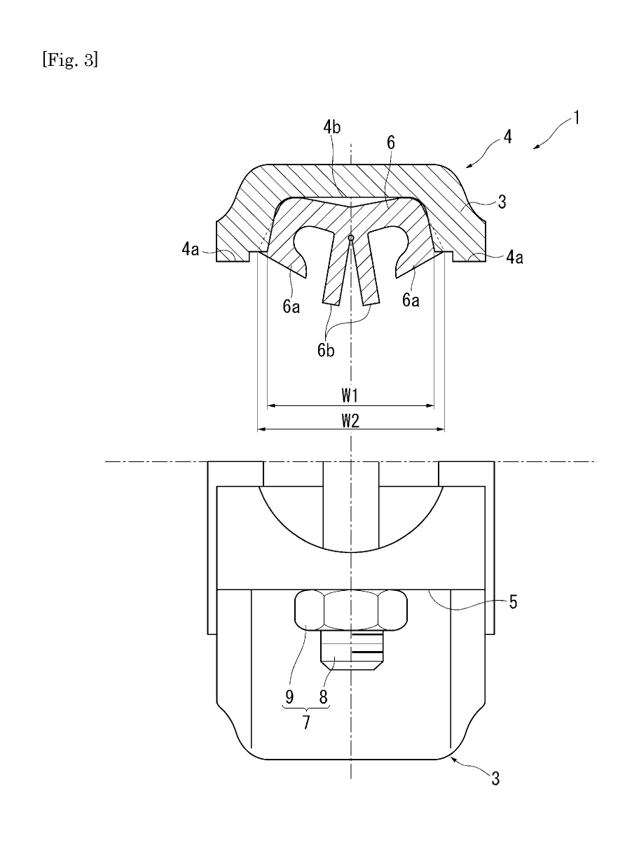

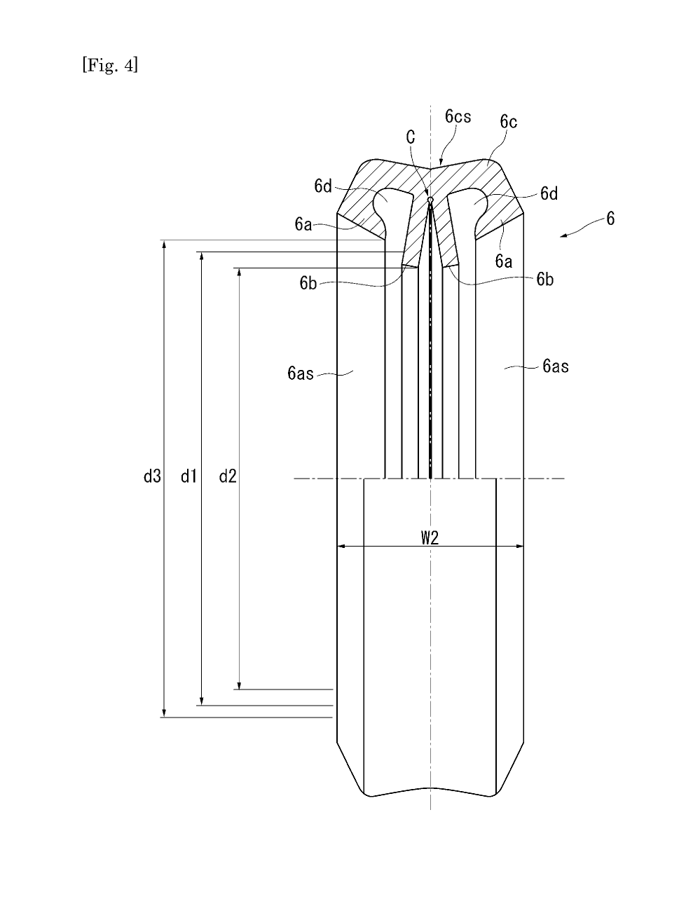

FIG. 1 is a sectional view of a housing type pipe joint 1 according to an embodiment of the present invention, taken along the plane parallel to an axial direction of pipes P when the housing type pipe joint 1 is mounted thereon. FIG. 2 is a sectional view taken along the line A-A in FIG. 1 (taken along the plane perpendicular to the axial direction of the pipes). FIG. 3 is a half sectional view of the housing type pipe joint 1, taken along the plane parallel to the axial direction. FIG. 4 is a half sectional view of a gasket 6. The housing type pipe joint 1 includes a pair of housing bodies 4, an annular gasket 6 formed from an elastic member, and a fastener 7 including a bolt 8 and a nut 9. These members are assembled into the housing type pipe joint 1.

Each of the housing bodies 4 includes a substantially semi-circular arc-shaped portion 3, a flange portion 5 that is formed at each circumferential end of the arc-shaped portion 3 and protrudes radially outward, a pair of lug portions (engaging portions) 4a that are arranged respectively on an axially-extending inner surface of the arc-shaped portion 3, and a concave portion 4b that defines an interior space of the arc-shaped portion 3 along the axial direction between the pair of lug portions 4a.

As shown in FIGS. 1 and 3, the lug portion (engaging portion) 4a protrudes radially inward from each side portion of the arc-shaped portion 3 and along the circumferential direction. The lug portion 4a engages with a groove (mounting portion) Pa that is circumferentially formed on each of a pair of pipes P at the end thereof, thereby connecting the pipes P to the housing type pipe joint 1.

The pair of pipes P are mounted substantially coaxially. However, the pipes P may be connected in a state where their axes are eccentric from each other or angled relative to each other to some extent. In the present embodiment, the mounting portion Pa of the pipe P is a groove (a concave portion), and the engaging portion 4a that engages with the mounting portion Pa is a lug portion (a convex portion). However, the mounting portion Pa may be a convex portion, and the engaging portion 4a may be a groove (a concave portion).

As shown in FIG. 4, the gasket 6 includes a cylindrical body portion 6c, a pair of gasket lip portions 6a that extend radially inward from both axial-end sides of the body portion 6c, and a pair of gasket tongue portions 6b that extend radially inward from an inner surface of the body portion 6c along the axial direction between the pair of gasket lip portions 6a (at a center portion C of the body portion 6c).

The pair of gasket tongue portions 6b have a ring shape. In a state where no load is applied to the gasket 6, the gasket tongue portions 6b come into contact with each other at their respective base ends at the center portion C, and also are spaced apart from each other in the axial direction to spread toward their distal ends. “The state where no load is applied to the gasket 6” refers to a state where the gasket 6 is not pressed. Rubber can be used for the gasket 6, for example. Examples of the rubber used for the gasket 6 can include ethylene propylene rubber (EPDM), nitrile butadiene rubber (NBR), acrylic rubber (ACM), silicon-based rubber (Si-based), fluoro rubber (FR), and styrene-butadiene rubber (SBR).

The gasket lip portion 6a includes an outer surface 6as that has a shape tapered toward the center of the axial direction and that is tightly attached to an outer surface of the pipe P to seal the outer surface. An interior space 6d is formed between the gasket lip portion 6a, the gasket tongue portion 6b, and the body portion 6c, and the gasket lip portion 6a is pressed against the pipe P by the pressure of liquid flowing through the pipe P. That is, the gasket 6 has a self-sealing structure in which sealing performance is improved by the pressure of liquid flowing through the pipe P.

Preferably, the pair of gasket tongue portions 6b have a rounded cross section between their respective base ends in place of having any slit, in order to prevent the gasket 6 from any cracks extending radially outward from the base ends of the gasket tongue portions 6b.

An inner diameter d₂ of the gasket tongue portion 6b is smaller than an outer diameter d₁ of the pipe P. An inner diameter d₃ of the gasket lip portion 6a is equal to or larger than the outer diameter d₁ of the pipe P. Therefore, in a state where the gasket 6 is pre-assembled into the housing bodies 4, the ends of the pair of pipes P can be inserted into the gasket 6 from both the axial sides of the housing type pipe joint 1 with the ends of the pipes P coaxially butting against each other, and then a bolt and a nut that have been pre-assembled into the opposed flange portions of the housing bodies are fastened to fix the ends of the pipes P, thereby constituting an insert-type housing type pipe joint.

The inner diameters d₂ and d₃ refer to the inner diameter of the narrowest part of the gasket tongue portion 6b and the gasket lip portion 6a, respectively.

As viewed in a cross-section parallel to the axial direction, a width W2 of the gasket 6 in a state where no load is applied thereto is larger than a width W1 of the concave portion 4b. Therefore, when the gasket 6 is accommodated in the concave portion 4b to be pre-assembled into it, the gasket 6 is locked by the concave portion 4b to prevent the gasket 6 from coming off and the axial center from displacing. When the gasket 6 is accommodated in the concave portion 4b, the gasket 6 is slightly compressed in the axial direction, however, not to the extent where the distal ends of the gasket tongue portions 6b touch each other. In a state where no load is applied to the gasket 6, an outer surface 6cs of the body portion 6c of the gasket 6 is concave at the center portion, and is raised radially outward to both ends. As described later, when the distal ends of the gasket tongue portions 6b are pressed by the pipes P and touch each other, the body portion 6c is deformed about the center portion C, and the outer surface 6cs becomes a substantially flat surface along the axial direction, and is tightly attached to the concave portion 4b.

The widths W2 and W1 are the maximum width of the gasket 6 and the concave portion 4b, respectively.

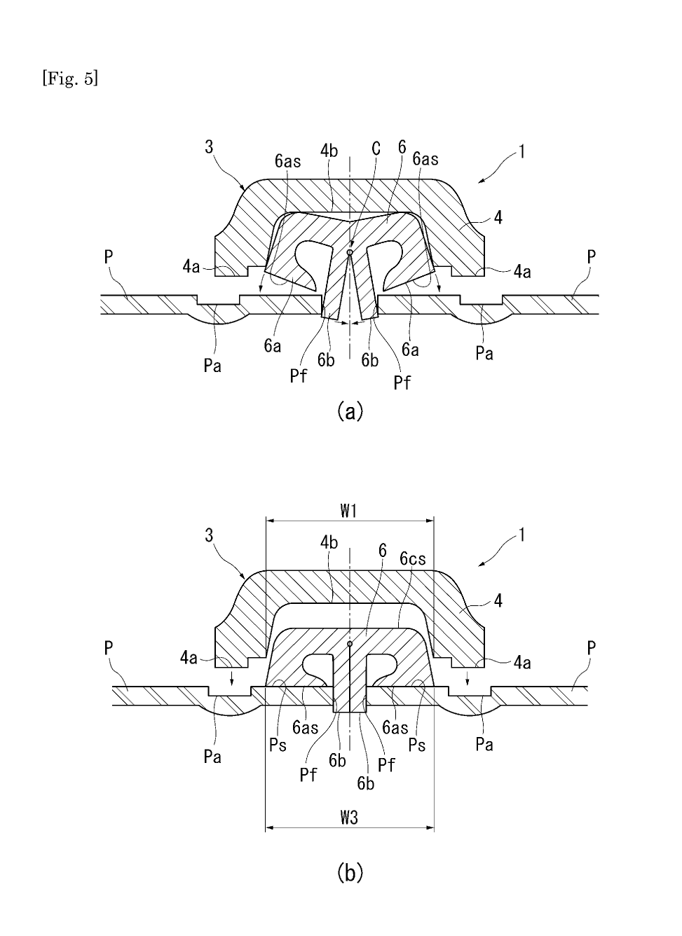

Next, an operation of the gasket 6 when the pipes P are connected to the housing type pipe joint 1 is described with reference to FIGS. 5. First, the housing type pipe joint is in a pre-assembled state where the gasket 6 is accommodated in the concave portion 4b, and the bolt 8 is inserted into bolt holes of the opposed flange portions 5 of the housing bodies 4 and is loosely pre-fastened by the nut 9.

As shown in FIG. 5(a), the ends of the pair of pipes P formed with an annular groove Pa are inserted into the gasket 6 respectively from both the axial sides of the housing type pipe joint 1 that is pre-assembled. At this time, the ends of the pipes P can be easily inserted into the gasket 6 because the inner diameter d₃ of the gasket lip portion 6a is set larger than the outer diameter d₁ of the pipes P, as described above.

When the pipes P are further inserted into the gasket 6 in the axial direction, distal ends Pf of the pipes P respectively come into contact with the gasket tongue portions 6b, and the distal ends of the gasket tongue portions 6b are pressed in the arrow direction in FIG. 5(a) and touch each other (FIG. 5(b)). At this time, the body portion 6c is deformed so as to rotate downward about the center portion C of the body portion 6c, to which the base ends of the gasket tongue portions 6b are connected. Due to this deformation, the gasket lip portion 6a rotates in the arrow direction in FIG. 5(a), and the angle of the outer surface 6as relative to the axial direction becomes smaller (the outer surface 6as is substantially parallel to the axial direction). Therefore, at least a part of the outer surface 6as of the gasket lip portion is close to or comes into contact with the outer surface Ps of the pipe P. Further, due to the deformation of the body portion 6c, the outer surface 6cs becomes a substantially flat surface along the axial direction.

In this state, when the fastener 7 (the bolt 8 and the nut 9) that has been pre-fastened is further fastened, a clearance between the housing bodies 4 is reduced in the arrow direction in FIG. 5(b). The lug portion 4a engages with the groove Pa of the pipe P, the gasket 6 is completely accommodated in the concave portion 4b, and the pipes P are connected to the housing type pipe joint 1.

As described above, when the gasket lip portion 6a rotates, the angle of the outer surface 6as relative to the axial direction becomes smaller. Therefore, when the housing type pipe joint 1 is fully fastened to reduce a clearance between the housing bodies 4, the outer surface 6as of the gasket lip portion 6a can be easily tightly attached to the outer surface Ps of the pipe P. As a result of this, the gasket 6 (the gasket lip portion 6a) can be prevented from causing twists and wrinkles and from being excessively compressed, deterioration of the gasket can be suppressed even when the gasket is held for a long time, and degradation of sealing performance of the gasket and water leakage can be prevented.

Further, the gasket tongue portions 6b can position the pipes P at the time of connecting the pipes P, thereby improving workability.

In the present embodiment, in a state where the distal ends of the gasket tongue portions 6b are pressed respectively by the distal ends Pf of the pipes P and touch each other, a width W3 of the gasket 6 in the axial direction becomes equal to or smaller than the width W1 of the concave portion 4b. Therefore, the gasket 6 is completely accommodated in the concave portion 4b almost without being compressed, and accordingly the gasket 6 can be prevented from causing twists and wrinkles and being excessively compressed, as described above.

Further, in the present embodiment, due to the deformation of the body portion 6c, the outer surface 6cs becomes a substantially flat surface along the axial direction. Therefore, when the housing type pipe joint 1 is fully fastened, the outer surface 6cs is tightly attached to the concave portion 4b. Accordingly, the gasket 6 can be prevented from partially coming into contact with the concave portion 4b or from being excessively compressed.

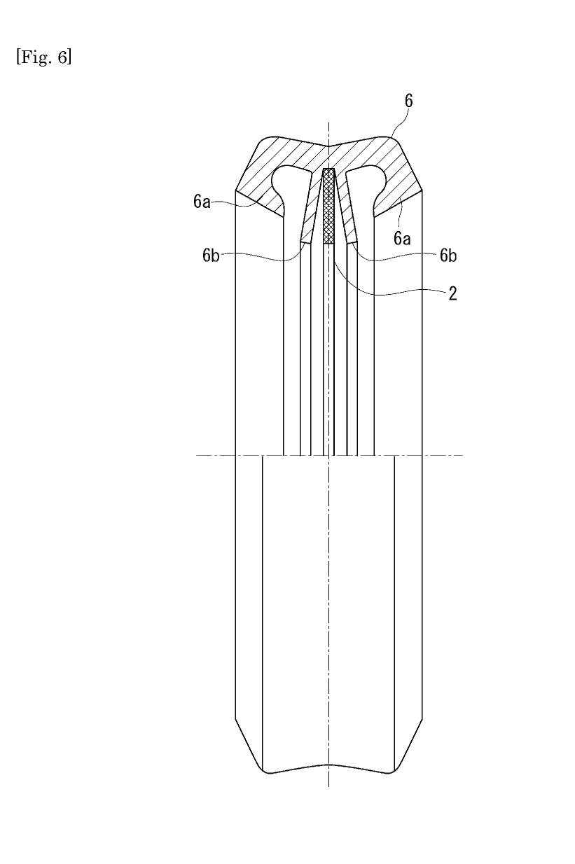

FIG. 6 is a half sectional view of the gasket 6 with a center ring 2 interposed between the gasket tongue portions 6b. The center ring 2 may be formed from an elastic material or a plastic material, and is preferably formed from rubber, resin or metal, in particular.

The gasket tongue portion 6b can be possibly deformed, damaged, or the like due to, for example, a pipe bending load. In this case, the gasket tongue portion 6b does not perform the function of positioning the pipes P. Therefore, the center ring 2 is provided to enable the pipes P to be reliably positioned.

The center ring may have an inverted V shape in cross section to further guide the opening between the gasket tongue portions 6b.

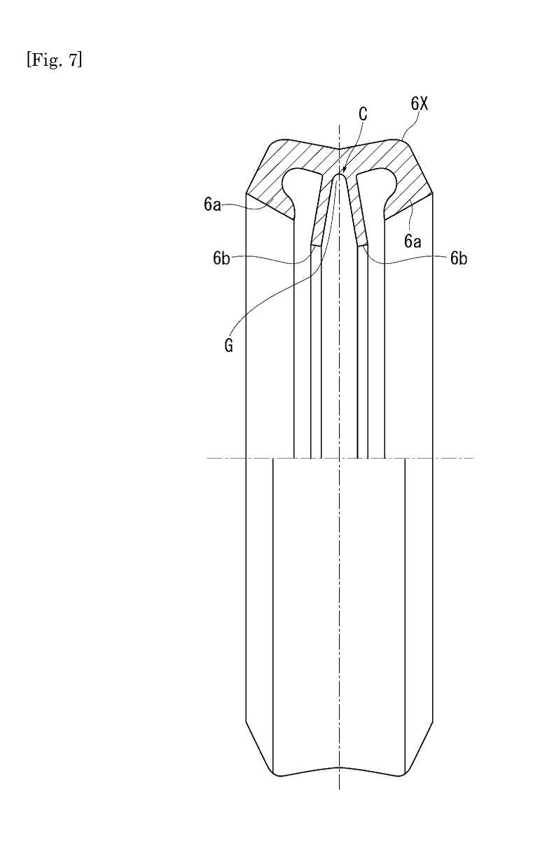

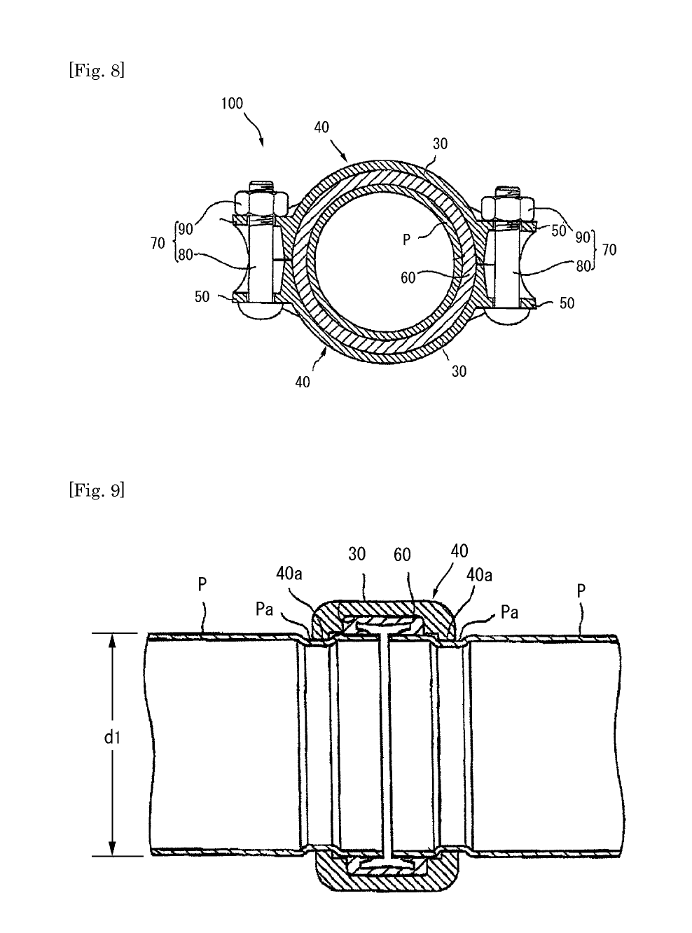

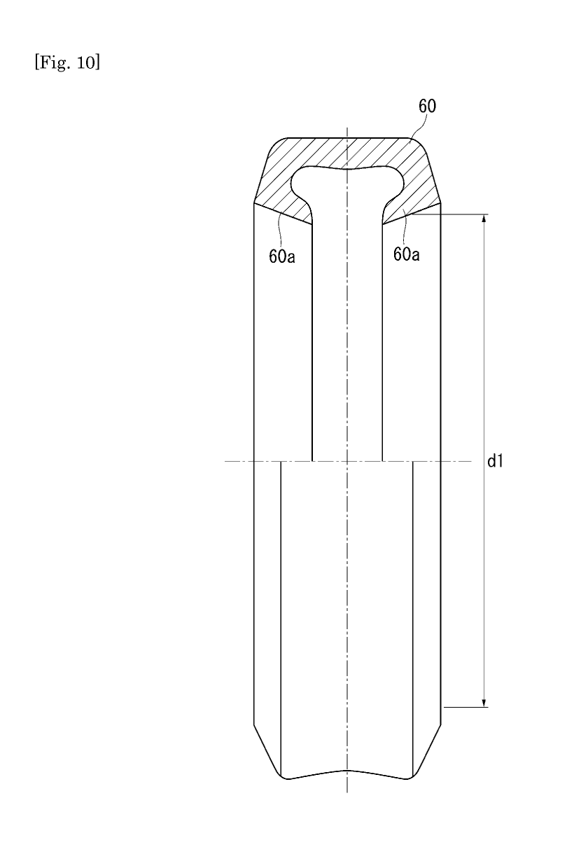

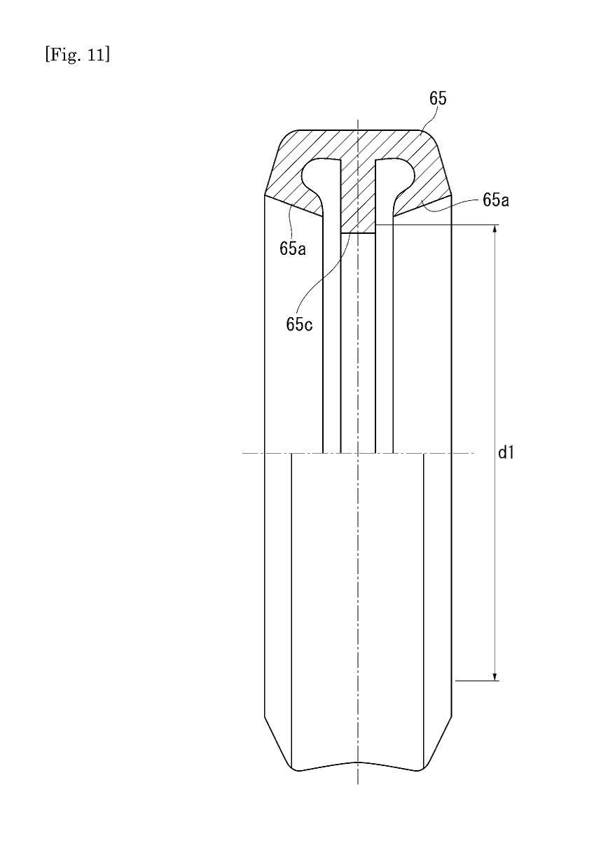

FIG. 7 is a half sectional view of a modification of the gasket. A gasket 6x is the same as the gasket 6 in FIG. 4 except that the size of a clearance between the gasket tongue portions 6b is different from that in the gasket 6. Therefore, the same reference numerals are used to represent the same elements, and descriptions thereof are omitted.

The base ends of the pair of gasket tongue portions 6b are spaced apart from each other with a gap G provided in the axial direction near the center portion C. Further, the gasket tongue portions 6b spread toward their distal ends. It is preferable that the pair of gasket tongue portions 6b are spaced apart from each other also on their base-end side, as described above, because a product is easily removed from a mold at the time of producing the gasket 6x. The gap G may have a rounded cross section in order to prevent the gasket 6x from any cracks extending radially outward from the base ends of the pair of gasket tongue portions 6b.

It should be understood that the present invention is not limited to the above embodiment, and covers various modifications and equivalents that fall within the spirit and scope of the invention. For example, in the above embodiment, a pair of (two) housings are used to surround and fix pipes to be connected together. However, three or more housings may be used to surround and fix the pipes. In a case of using three housings to fix the pipes, each of the housings includes a housing body shaped into an arc that is about a third of a circle, and these housings are arranged into an annular shape to surround the outer side of the pipes. Similarly, in a case of using four housings to fix the pipes, each of the housings includes a housing body shaped into an arc that is about a quarter of a circle. Further, adjacent parts of the respective housings may be connected by a hinge, and a fixing portion may be provided only at both circumferential ends of the connected housings. Furthermore, the fixing portion is not limited to the flange portion described above, and may be anything that fixes adjacent housings to each other when the housings surround the pipes.

The above embodiment shows a movable-type housing type pipe joint that allows relative movement between the pipes P and the housing bodies 4 (movement in the axial direction and the circumferential direction of the pipes P). However, the present invention is also applicable to a fix-type or half fix-type housing type pipe joint that regulates relative movement between the pipes P and the housing bodies 4 (movement in both or either one of the axial direction and the circumferential direction of the pipes P).

In the above embodiment, when the gasket tongue portions 6b are pressed by the distal ends Pf of the pipes P, the distal ends of the gasket tongue portions 6b touch each other. However, the distal ends of the gasket tongue portions 6b may be close to each other in place of touching each other.

1. A housing type pipe joint that connects a pair of pipes including a concave or convex mounting portion at an end thereof, the joint comprising:
a plurality of housing bodies, each of which includes an arc-shaped portion, a flange portion that is formed at each circumferential end of the arc-shaped portion and protrudes radially outward, a pair of engaging portions that are arranged respectively on an axially-extending inner surface of the arc-shaped portion and engage respectively with the mounting portion of the pipe, and a concave portion that defines an interior space of the arc-shaped portion along the axial direction between the pair of engaging portions;
an annular gasket that is formed from an elastic member and is accommodated in the concave portion of the housing body; and
a fastener that fastens the housing bodies at the flange portions, wherein
the gasket includes a cylindrical body portion, a pair of gasket lip portions that extend radially inward from both axial-end sides of the body portion, and a pair of gasket tongue portions that extend radially inward from an inner surface of the body portion along the axial direction between the pair of gasket lip portions, an outer surface of the gasket lip portion is tightly attached to an outer surface of the pipe, and is capable of sealing the outer surface,
in a state where no load is applied to the gasket, distal ends of the pair of gasket tongue portions are spaced apart from each other in the axial direction, and
when the distal ends of the pair of gasket tongue portions are pressed to be close to each other in the axial direction, the body portion is deformed about a vicinity of base ends of the pair of gasket tongue portions, and due to this deformation, the pair of gasket lip portions rotate, and an angle of the outer surface of the gasket lip portion relative to the axial direction becomes smaller.

2. The housing type pipe joint according to claim 1, wherein
as viewed in the axial direction, a width of the gasket in a state where no load is applied thereto is larger than a width of the concave portion, and
when the distal ends of the pair of gasket tongue portions are pressed to be close to each other in the axial direction, the width of the gasket becomes equal to or smaller than the width of the concave portion, and the gasket is completely accommodated in the concave portion.

3. The housing type pipe joint according to claim 1, wherein a center ring is interposed between the pair of gasket tongue portions.

4. The housing type pipe joint according to claim 3, wherein the center ring is formed from rubber, resin, or metal.

5. The housing type pipe joint according to claim 2, wherein a center ring is interposed between the pair of gasket tongue portions.
